(19) United States
(12) Patent Application Publication
(10) Pub. No.: US 2026/0245992 A1
(43) Pub. Date: Aug. 20, 2026

(54) SINGLE DIRECT CURRENT BLOCK POWER DISTRIBUTION TO MULTI-INVERTERS

(71) Applicant: Fluence Energy, LLC, Arlington, VA (US)

(72) Inventors: Avijit N. Saha, Bangalore (IN); Niloy Sarkar, Jalpaiguri (IN); Atul Pathak, Bhopal (IN); Nafisa Mujawar, Mudol (IN); Pritam Kumar, Bengaluru (IN); Naresh Krishna, Tiruvallur (IN)

(73) Assignee: Fluence Energy, LLC, Arlington, VA (US)

(21) Appl. No.: 19/538,907

(22) Filed: Feb. 12, 2026

Related U.S. Application Data
(60) Provisional application No. 63/759,422, filed on Feb. 17, 2025.

(51) Int. Cl. H01M 10/42; H01M 10/625; H01M 50/569; H02M 1/00

(52) U.S. Cl. CPC H01M 10/425; H01M 10/625; H01M 50/569; H02M 1/007; H01M 2220/20

(57) ABSTRACT

A single direct current block enclosure power distribution to multi-inverter systems includes coupling, serially, a plurality of first battery modules to form a first battery pack where a first switch control is coupled to the first battery pack. A second battery pack includes a plurality of serially coupled second battery modules and a second switch control coupled to the second battery pack. Based on an amount of energy mismatch between the second battery pack and either the first power conversion module or the second power conversion module a determination is made as to when to couple the second switch control to a first power conversion module or to a second power conversion module.

### CROSS-REFERENCE TO RELATED APPLICATIONS

This application claims the benefit of U.S. Provisional Application Number 63/759,422, filed February 17, 2025, which is hereby incorporated by reference in its entirety.

### INTRODUCTION

The concepts described herein relate generally to energy storage systems, and more specifically, to modular energy storage systems coupled to multiple inverters.

Modular energy storage systems include multiple individual energy storage enclosures interconnected to provide varied levels of storage capacity. Energy storage systems can be used to store additional power produced by an external power source during periods of reduced demand and provide additional power to external power sources during periods of increased demand.

Each individual energy storage enclosure includes multiple battery modules containing multiple submodules. Each battery submodule module includes multiple individual battery cells disposed adjacent to one another. Battery submodules, while potentially constructed using the same type and amount of material, may provide varying amounts of power producing a mismatched energy transfer to an inverter.

Energy mismatch between a power distribution enclosure and an inverter produces inefficiencies. Such energy mismatch may be addressed through the use of partially populated enclosures, or the use of different size enclosures within a core, or the configuration of distinct types of battery subsystems within an enclosure. However, these approaches are cost and energy inefficient.

Thus, it would be advantageous to provide an optimized system and method of coupling battery submodules to multiple inverters that provide a matched level of energy transfer.

### SUMMARY

Disclosed herein are systems regarding energy storage enclosure systems and methods for single direct current block enclosure power distribution to multi-inverter systems.

An aspect of the disclosure may include an energy storage enclosure system for power distribution that includes a first battery pack with a plurality of serially coupled first battery modules and a first switch control coupled to the first battery pack. The system may also include a second battery pack with a plurality of serially coupled second battery modules and a second switch control coupled to the second battery pack. The system may also include where the second switch control may be optionally coupled to a first power conversion module or to a second power conversion module, and where the option to be coupled to the first power conversion module or the second power conversion module is based on an amount of energy mismatch between the second battery pack and either the first or the second power conversion module.

Another aspect of the system may include where the first battery pack is electrically isolated from the second battery pack.

Another aspect of the system may include where the first battery pack and the second battery pack comprise the same type and number of battery modules.

Another aspect of the system may include a first energy storage enclosure coupled to the first power conversion module, and a second energy storage enclosure coupled to the second power conversion module.

Another aspect of the system may include a control system controller to determine when the second switch control is to be coupled to the first power conversion module or to the second power conversion module.

Another aspect of the system may include an array controller to control the coupling of the second switch control of the first energy storage enclosure to the first power conversion module or the second power conversion module, and the coupling of the second energy storage enclosure to the first power conversion module or the second power conversion module.

Another aspect of the system may include where the first energy storage enclosure and the second energy storage enclosure are both fully populated with one or more battery packs.

Another aspect of the system may include where at least one of the first power conversion module and the second power conversion module comprises an analog/digital inverter.

Another aspect of the system may include where at least one of the first power conversion module and the second power conversion module is coupled to an external power source.

Another aspect of the system may include where at least one of the first power conversion module and the second power conversion module is configured to convert alternating current power to direct current power and/or to convert direct power to alternative current power.

An aspect of the disclosure may include a method for single direct current block enclosure power distribution to multi-inverter systems including coupling, serially, a plurality of first battery modules to form a first battery pack and a coupling a first switch control to the first battery pack. The method may further include coupling, serially, a plurality of second battery modules to form a second battery pack and a coupling of a second switch control to the second battery pack. The method may also include determining, based on an amount of energy mismatch between the second battery pack and either the first power conversion module or the second power conversion module, when to couple the second switch control to a first power conversion module or to a second power conversion module, and a coupling of the second switch control to the first power conversion module or to the second power conversion module is based on the determination.

Another aspect of the disclosure may further include a method for electrically isolating the first battery pack from the second battery pack.

Another aspect of the disclosure may further include a method where the first battery pack and the second battery pack include the same type and number of battery modules.

Another aspect of the disclosure may further include a method for coupling a first energy storage enclosure to the first power conversion module, and a second energy storage enclosure to the second power conversion module.

Another aspect of the disclosure may further include a method for coupling an array controller configured to control the coupling of the second switch control of the first energy storage enclosure to the first power conversion module or the second power conversion module, and the coupling of the second energy storage enclosure to the first power conversion module or the second power conversion module.

Another aspect of the disclosure may further include a method where the energy storage enclosure and the second energy storage enclosure are both fully populated with one or more battery packs.

Another aspect of the disclosure may further include a method where at least one of the first power conversion module and the second power conversion module comprises an analog/digital inverter.

Another aspect of the disclosure may further include a method where at least one of the first power conversion module and the second power conversion module is coupled to an external power source.

Another aspect of the disclosure may further include a method of converting, using at least one of the first power conversion module and the second power conversion module, alternating current power to direct current power and/or to convert direct power to alternative current power.

An aspect of the disclosure may include an energy storage enclosure system that includes a first battery pack with a plurality of serially coupled first battery modules and a first switch control coupled to the first battery pack. The system may also include a second battery pack with a plurality of serially coupled second battery modules, where the first battery pack is electrically isolated from the second battery pack, and where the first battery pack and the second battery pack include the same type and number of battery modules. The system may also include a second switch control coupled to the second battery pack, a first energy storage enclosure coupled to the first power conversion module, and a second energy storage enclosure coupled to the second power conversion module with a control system controller to determine when the second switch control is to be coupled to the first power conversion module or to the second power conversion module. The system may also include an array controller to control the coupling of the second switch control of the first energy storage enclosure to the first power conversion module or the second power conversion module, and the coupling of the second energy storage enclosure to the first power conversion module or the second power conversion module, where the second switch control may optionally be coupled to the first power conversion module or to the second power conversion module. Further, the system may include where the option to couple to the first power conversion module or the second power conversion module is based on an amount of energy mismatch between the second battery pack and either the first power conversion module or the second power conversion module, and where the first energy storage enclosure and the second energy storage enclosure are both fully populated with one or more battery packs. The system may also include where at least one of the first power conversion module and the second power conversion module includes an analog/digital inverter, where at least one of the first power conversion module and the second power conversion module is coupled to an external power source, and where at least one of the first power conversion module and the second power conversion module may convert alternating current power to direct current power and/or to convert direct power to alternative current power.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 schematically illustrates an energy storage system including a plurality of energy storage enclosures, in accordance with the disclosure.

FIG. 2 is a schematic isometric view of another energy storage system in accordance with one aspect of the disclosure.

FIG. 3 is a schematic front view of the energy storage system in accordance with one aspect of the disclosure.

FIG. 4 is a schematic isometric view of still another energy storage system in accordance with one aspect of the disclosure.

FIG. 5 illustrates a schematic diagram of a single direct current block enclosure with multiple parallel switched buses, in accordance with one aspect of the disclosure.

FIG. 6 illustrates multiple single direct current block enclosures, each enclosure with multiple parallel switched buses coupled to multiple inverter systems, in accordance with one aspect of the disclosure.

FIG. 7 illustrates a method of a single direct current block enclosure power distribution to multi-inverter systems, in accordance with one aspect of the disclosure.

The appended drawings are not necessarily to scale and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The present disclosure is susceptible of embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

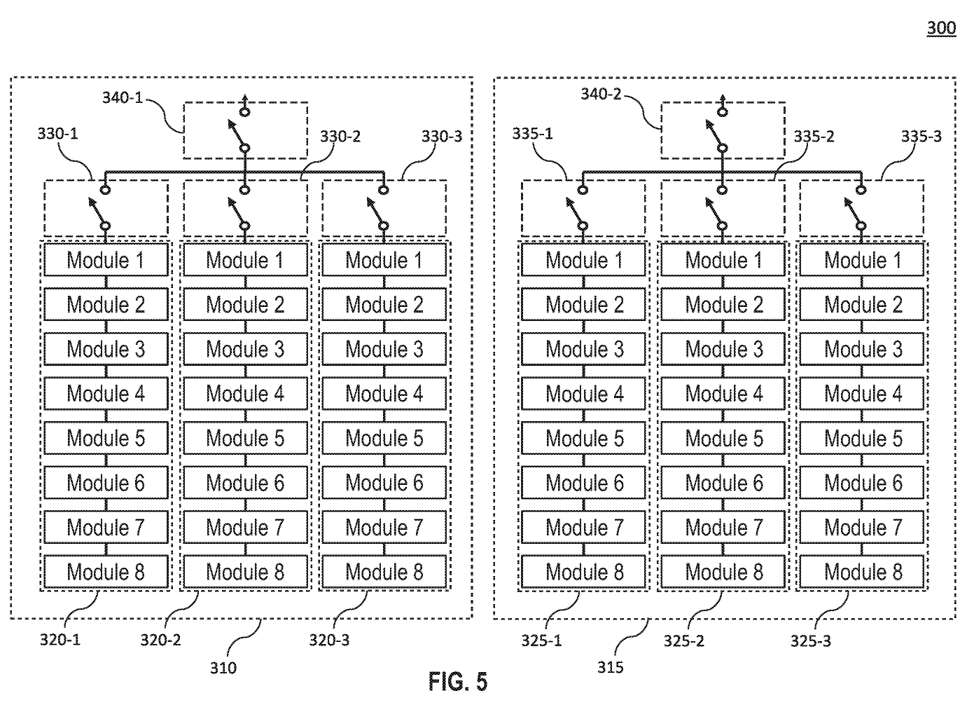

Referring to the drawings, the leftmost digit of a reference number identifies the drawing in which the reference number first appears (e.g., a reference number ’310’ indicates that the element so numbered is first labeled or first appears in FIG. 5). Additionally, elements which have the same reference number, followed by a different letter of the alphabet or other distinctive marking (e.g., an apostrophe), indicate elements which may be the same in structure, operation, or form but may be identified as being in different locations in space or recurring at different points in time (e.g., reference numbers “102a” and “102b” may indicate two different input devices which may be functionally the same, but may be located at different points in a simulation arena).

As used herein, the term “system” refers to mechanical and electrical hardware, software, firmware, electronic control componentry, processing logic, and/or processor device, individually or in combination, including without limitation: application specific integrated circuit (ASIC), an electronic circuit, a processor (shared, dedicated, or group) that executes one or more software or firmware programs, memory device(s) that electrically store software or firmware instructions, a combinatorial logic circuit, and/or other components that provide the described functionality.

As employed herein, terms such as “vertical”, “horizontal”, “left”, “right”, “upper”, “lower”, “top”, “bottom” and similar expressions are non-limiting terms that merely describe the various elements as illustrated in the Figures and are not intended to limit the scope of the disclosure.

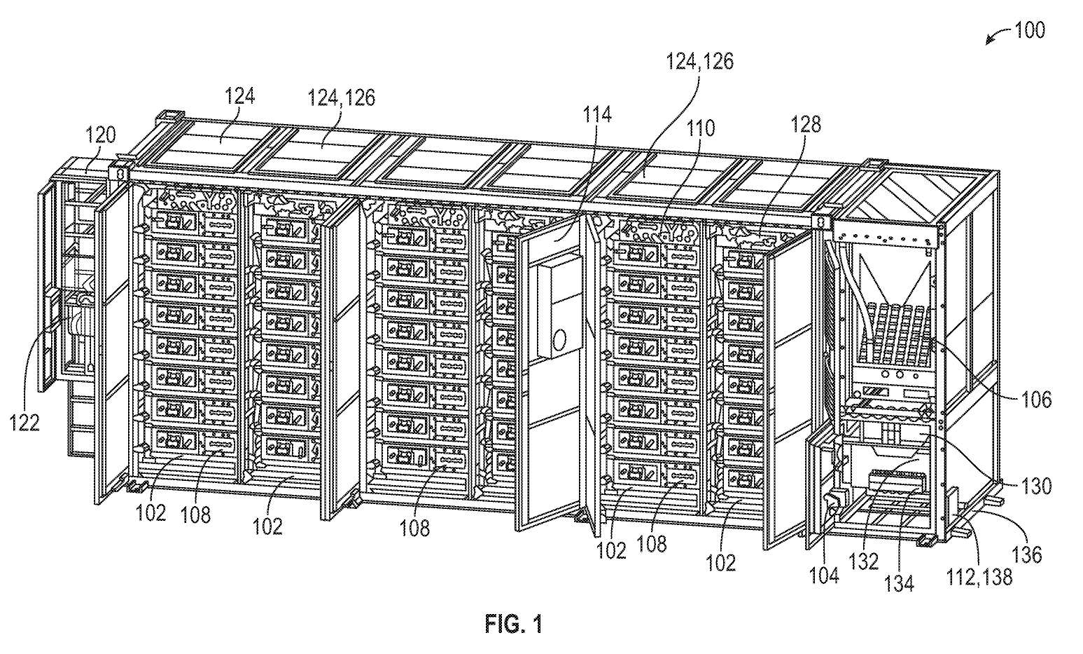

Referring to the drawings, FIG. 1 schematically illustrates an isometric view of an energy storage system 100 according to an embodiment of the present disclosure. The energy storage system 100 includes the plurality of energy storage enclosures 102, a controller 104, a cooling system (or chiller) 106 (which may be external or internal within an enclosure as would be known by one of ordinary skill in the art), multiple power conversion modules 108, multiple direct current protection modules (DCPM) 110, auxiliary components 112, a heating, ventilation, and air conditioning (HVAC) system 114, a fire panel 116, and plumbing 118. The energy storage system 100 may also include a DC disconnector box 120, a DC disconnector 122, multiple deflagration panels 124, multiple passive vents 126, a DC-DC converter 128, an uninterruptible power supply (UPS) 130, a master control board (MCB) 132, a power distributor 134, a grounding point 136, an enclosure to enclose connections 138 and multiple battery modules 140. In various embodiments, the energy storage system 100 implements a battery energy storage system (BESS). In some embodiments, the energy storage system 100 may be one or more of a battery cell, a battery module, a battery pack, a battery enclosure, a battery node, and/or a battery core.

The plurality of energy storage enclosures 102 may be coupled to one another electrically. The plurality of energy storage enclosures 102, individually and collectively, may operate to store alternating current (AC) power delivered from an external power source 150 as direct current (DC) power, for example but not limited to when the demand for power from the external power source 150 is lower than the external power source 150 is operable to generate, and/or to provide DC power to the external power source 150. For example, when the demand for power is higher than the external power source 150 may be used operable to provide additional energy. It should be appreciated that the plurality of energy storage enclosures 102 may be coupled to one another not only electrically, but also mechanically, and/or fluidly.

To facilitate the conversion of AC power to DC power and DC power to AC power, the power conversion module 108 may be used to standardize power input and output between the plurality of energy storage enclosures 102 and the external power source 150. The power conversion module 108 may include a converter to convert AC power to DC power, and/or DC power to AC power.

The external cooling system 106 may be coupled to the plurality of energy storage enclosures 102 and the controller 104. The external cooling system may provide coolant at a first temperature T₁ to the plurality of energy storage enclosures 102 through at least one input port and receive coolant from the plurality of energy storage units at a second temperature T₂ from at least output port, such that T₁ is lower than T₂.

The external cooling system 106 may include, for example, a heat exchanging system having a pump, a condenser, a heat exchange, and a sump. It should be appreciated that the at least one input port and the at least one output port may include more than one input port and/or one output port, and each of which may be disposed in one or more of the multiple energy storage enclosures 102.

The external power source 150 may be coupled to the plurality of energy storage enclosures 102. The external power source 150 may be operable to provide AC power converted to DC power to the plurality of energy storage enclosures 102 to be stored as DC power, and to receive AC power converted from DC power from the plurality of energy storage enclosures 102, as discussed above.

The controller 104 may be in communication with the plurality of energy storage enclosures 102, the power conversion module 108, the external cooling system 106, and the external power source 150, and may be used to control the aforementioned plurality of energy storage enclosures 102, the power conversion module 108, the external cooling system 106, and their communication with the external power source 150.

The term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated memory component(s) in the form of transitory and/or non-transitory computer readable storage medium (or memory) component(s) and storage devices (read only, programmable read only, random access, hard drive, etc.). The non-transitory computer readable storage medium/memory component may be capable of storing machine readable instructions in the form of one or more software or firmware programs or routines, combinational logic circuit(s), input/output circuit(s) and devices, signal conditioning and buffer circuitry and other components that may be accessed by one or more processors to provide a described functionality. Input/output circuit(s) and devices include analog/digital inverters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables.

The energy storage enclosures 102 may each include one or more battery packs, and a plurality of battery modules disposed within each battery pack, according to an embodiment of the present disclosure. Further, each battery module may also contain multiple battery submodules that may house individual battery cells (not shown).

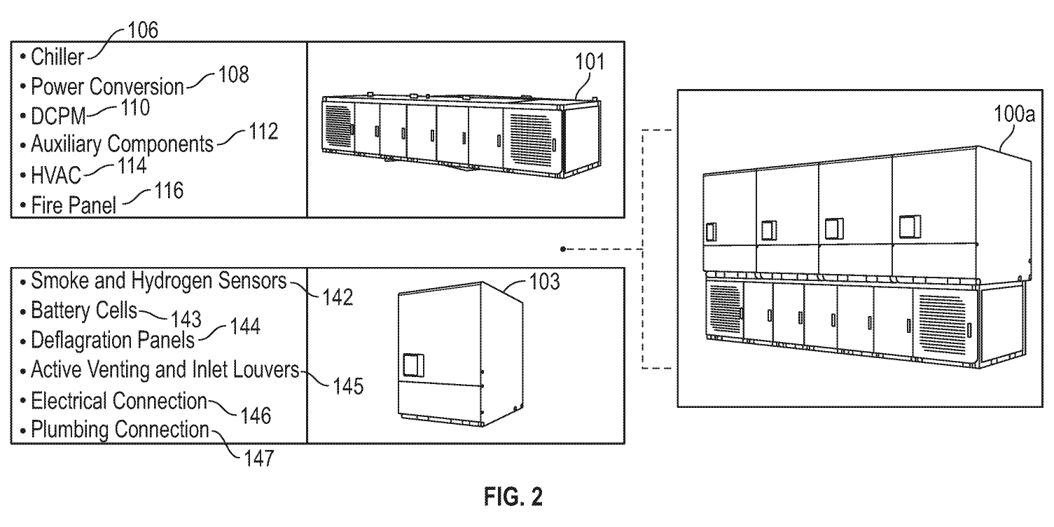

Referring to FIG. 2, a schematic isometric view of another energy storage system 100a is shown in accordance with one aspect of the disclosure. The energy storage system 100a generally includes a smartskid 101 and multiple (e.g., 4) pods 103 coupled to the smartskid 101. The smartskid 101 includes a cooling system 106, a power conversion system 108, a DCPM 110, auxiliary components 112, an HVAC 114 and a fire panel 116. Each pod 103 includes smoke and hydrogen sensor 142, battery cells 143, deflagration panels 144, active venting and inlet louvers 145, electrical connections 146 and plumbing connections 147.

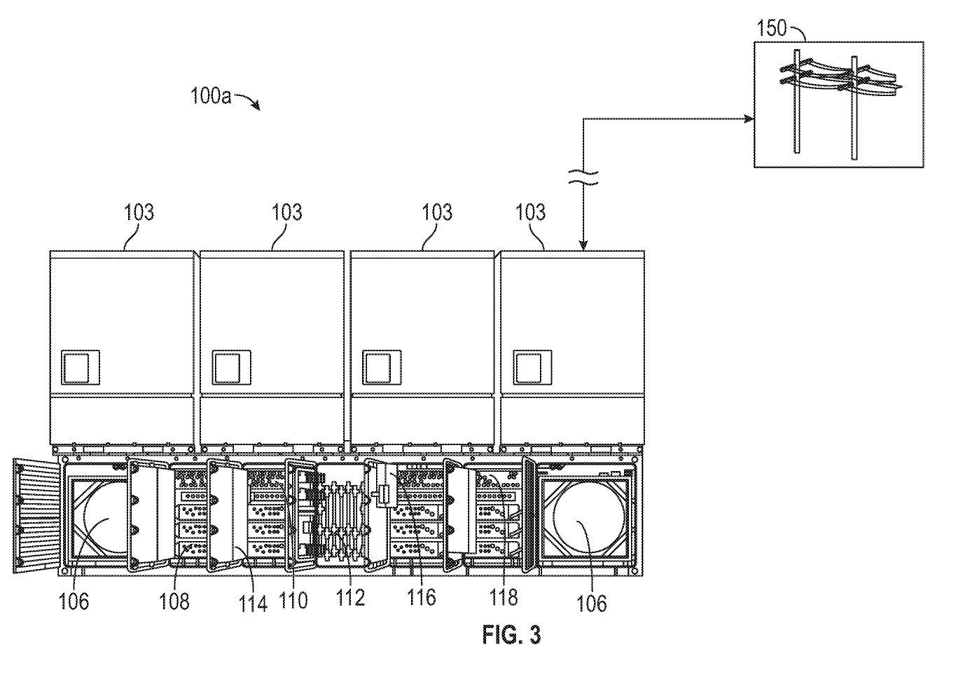

Referring to FIG. 3, a schematic front view of the energy storage system 100a is shown in accordance with one aspect of the disclosure. The smartskid 101 generally includes two cooling systems 106, the power conversion system 108, the DCPM 110, the auxiliary components 112, the HVAC 114, the fire panel 116 and plumbing 118. The energy storage system 100a (and 100 shown in FIG. 1) may be coupled with the external power source 150.

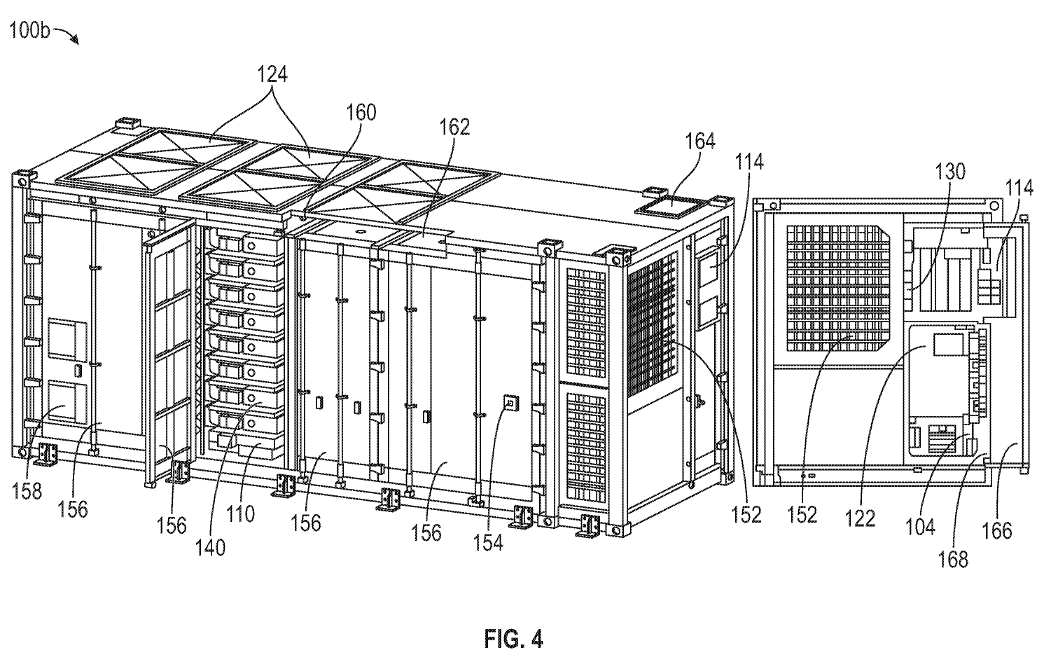

Referring to FIG. 4, a schematic isometric view of yet another energy storage system 100b is shown in accordance with one aspect of the disclosure. The energy storage system 100b generally includes the controller 104, the DCPM 110, the HVAC 114, the DC disconnect switch 122 the deflagration panels 124, The UPS 130, the battery modules 140, a chiller compartment 152, a fast stop (F-stop) 154, an enclosure door 156, an inlet louver 158, multi detectors 160, a hydrogen (H₂) gas detector 162, a vent panel 164, an enclosure side door 166, and a battery cooling plate (BCP) door 168.

FIG. 5 illustrates a diagram 300 of a single direct current block enclosure with multiple parallel switched buses, according to an embodiment of the present disclosure. Diagram 300 illustrates a single DC block enclosure 310 and DC block enclosure 315. An example of a single DC block enclosure 310 may also be viewed as energy storage enclosures 102 discussed in FIG. 1. In an embodiment, a single DC block enclosure 310 may include one or more battery packs. In an embodiment, DC block enclosure 310, illustrated in FIG. 5, may include two sets of battery packs. The first set of battery packs may include battery pack 320-1, battery pack 320-2, and battery pack 320-3. The second set of battery packs may include battery pack 325-1, battery pack 325-2, and battery pack 325-3. Thus, in this example, DC block enclosure 310 illustrates the use of two separate sets of battery packs with each set containing three battery packs. The number of battery packs within a set of battery packs is arbitrary and meant as an illustration of a possible configuration. For example, in other embodiments the number of total battery packs 320 and 325 may be more or less, for example, three, fifteen, or twenty.

Further, each battery pack 320 and battery pack 325 may each contain multiple battery submodules, labeled as module 1, module 2, module 3, module 4, module 5, module 6, module 7, and module 8. The number of battery packs and battery submodules are purely examples and are not meant to limit the scope of the disclosure. In some embodiments, each battery pack 320 and battery pack 325 may contain hundreds of individual battery cells serially coupled and grouped into modules, or submodules shown in FIG. 5.

Each battery pack 320 may also be coupled to a DC disconnector switch 330. And, in similar fashion, each battery pack 325 may also be coupled to a DC disconnector switch 335. Thus, as shown DC disconnector switch 330 may include DC disconnector switch 330-1, DC disconnector switch 330-2, and DC disconnector switch 330-3, each of which may be coupled to its corresponding battery pack 320-1, battery pack 320-2, and battery pack 320-3. Similarly, DC disconnector switch 335 may include DC disconnector switch 335-1, DC disconnector switch 335-2, and DC disconnector switch 330-3, each of which may be coupled to its corresponding battery pack 325-1, battery pack 325-2, and battery pack 325-3.

Finally, DC block enclosure 310 may also include a main DC box switch 340 for each of the battery packs. Thus, the main DC box switch 340-1 may be coupled to battery pack 320, which in this example includes battery pack 320-1, battery pack 320-2, and battery pack 320-3. Similarly, the main DC box switch 340-2 may be coupled to battery pack 325, which in this example includes battery pack 325-1, battery pack 325-2, and battery pack 325-3.

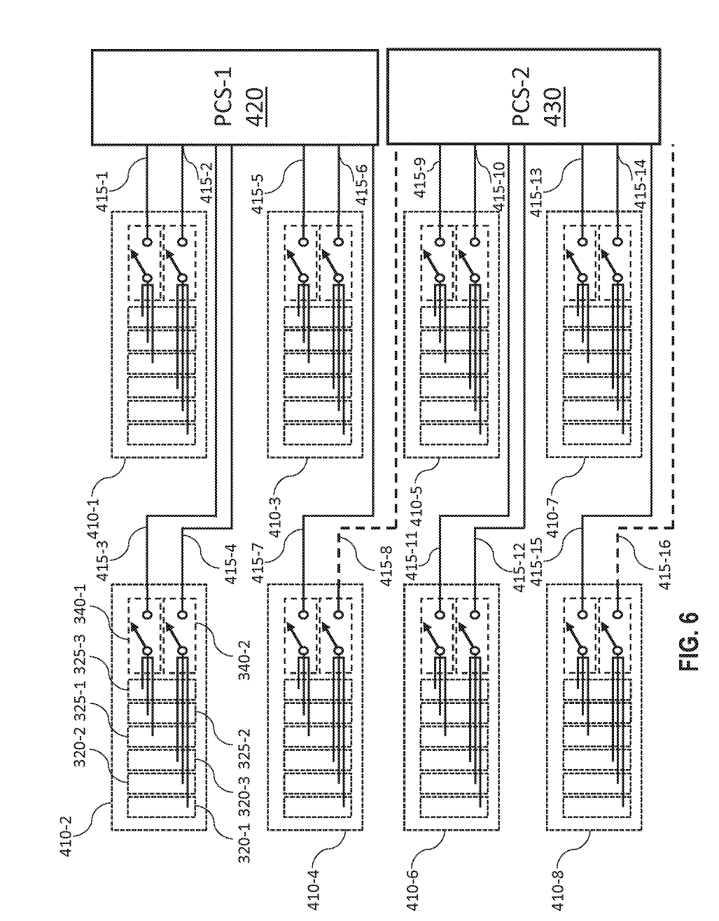

FIG. 6 illustrates a diagram 400 of multiple single direct current block enclosures, each enclosure with multiple parallel switched buses coupled to multiple inverter systems, according to an embodiment of the present disclosure. Diagram 400 illustrates the use of multiple enclosures, for example DC block enclosure 310 of FIG. 5 is illustrated as DC block enclosure 410 where some of the additional detail of DC block enclosure may be present but is not shown. DC block enclosure 410 is shown with eight instances shown as DC block enclosure 410-1, DC block enclosure 410-2, DC block enclosure 410-3, DC block enclosure 410-4, DC block enclosure 410-5, DC block enclosure 410-6, DC block enclosure 410-7, and DC block enclosure 410-8. The actual number of DC block enclosures is a way to illustrate the concept of the disclosure and is not meant to be limiting in implementation or scope. Each of the DC block enclosures 410 may also include the set of battery packs 320 and battery packs 325 as discussed in FIG. 5. Each of the DC block enclosures 410 may also include a main DC box switch 340-1 and main DC box switch 340-2, where each of the main DC box switches 340 may connect/disconnect its set of battery packs to a power conversion module, or inverter, such as power conversion module 420 and power conversion module 430 and labeled as PCS-1 and PCS-2.

An inverter, such as power conversion module 420 and power conversion module 430 may each be rated at a particular capacity. For efficiency it is desired to match the capacity of attached DC block enclosures to the capacity of the power conversion module. If the attached DC block enclosures fail to provide enough energy to a particular power conversion module, then that power conversion module is underutilized. Similarly, if the DC block enclosures have excess energy capacity that the power conversion module cannot handle then the DC block enclosures are underutilized. Such underutilization or inefficiencies may be referred to as energy mismatch.

To address energy mismatch, such as when a DC block enclosure fails to provide enough energy to a particular power conversion module a solution may be to use a power conversion module of a lesser capacity. However, such a solution may result in the use of different power conversion modules in an installation, thus causing difficulties in maintenance and possible increased costs.

Similarly, if a DC block enclosure has excess energy capacity to a particular power conversion module a possible solution may be to modify the DC block enclosure to have fewer battery packs or include battery packs of a lower energy rating. Again, such an approach introduces inefficiencies in terms of continuity of configurations, maintenance, operational costs, and the like.

The approach presented in FIG. 6 is to allow each DC bus or group of DC buses to connect with multiple inverter systems. For example, all of the output 415-1 and output 415-2 of DC block enclosure 410-1, output 415-3 and output 415-4 of DC block enclosure 410-2, and output 415-5 and output 415-6 of DC block enclosure 410-3 may be coupled to the inverter, power conversion module 420. However, as an example, if all of the output 415-7 and output 415-8 of DC block enclosure 410-4 were to be coupled to power conversion module 420 then such a set of connections may exceed the capacity of power conversion module 420. Thus, an enclosure or array controller may sense the imbalance or mismatch of energy and instead of connecting the output 415-8 of main DC box switch 340-2 of DC block enclosure 410-4 to power conversion module 420, that energy may be directed to another power conversion module, for example power conversion module 430.

The same concept may then be applied for the remainder of the system, for example as shown in FIG. 6 where output 415-8 of DC block enclosure 410-4, output 415-9 and output 415-10 of DC block enclosure 410-5, and output 415-11 and output 415-12 of DC block enclosure 410-6, output 415-13 and output 415-14 of DC block enclosure 410-7, and output 415-15 and an output 415-16 of DC block enclosure 410-8, may be coupled to the inverter, power conversion module 430.

Diagram 400 of FIG. 6 illustrates the concept of utilizing two sets of battery packs in a single enclosure but is equally applicable for any division of battery packs. For example, each battery pack, for example battery pack 320-1, battery pack 320-2, battery pack 320-3, battery pack 325-1, battery pack325-2, and battery pack 325-3 may each be connected to a main DC box switch and controlled using a control system controller or an array controller, not shown, to determine how to best match and connect one or more DC block enclosures to one or more power conversion modules. A control system controller may be utilized within an enclosure to monitor and control how and when to connect a main DC box switch, or its equivalent, to a particular power conversion module. An array controller may be a system type controller used to monitor and control multiple DC block enclosures. Further, such controllers may include processors, sensors, memory, etc., that execute software to achieve their functionality.

Further, the battery cells may be more or less conservative in rating the capacity of a battery cell. Thus, the actual capacity of a battery pack 320 may be significantly higher than its associated rating.

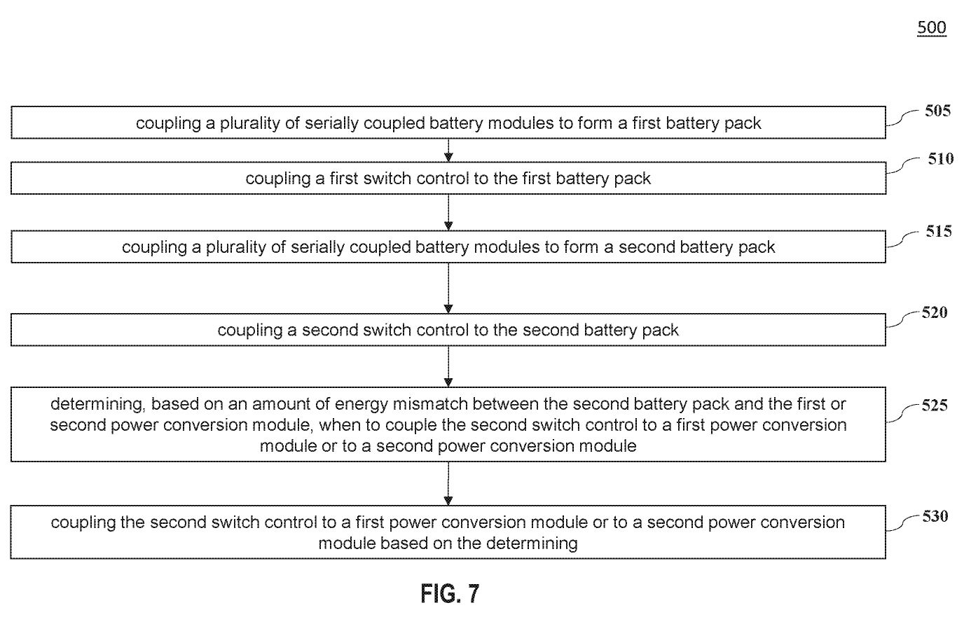

FIG. 7 illustrates method 500 for single direct current block enclosure power distribution to multi-inverter systems, according to an embodiment of the present disclosure. FIG. 7 may begin with step 505 with a coupling of a plurality of serially coupled battery modules to form a first battery pack. As discussed in FIG. 5, a battery pack may be viewed as battery packs 320 and 325. For example, battery pack 320-1 includes multiple serially couple battery modules, shown as module 1 through module 8. The number of serially coupled battery modules, or battery submodules may vary depending on the type and configuration of a particular battery pack.

At step 510 the method continues with a coupling of a first switch control to the first battery pack. As shown in FIG. 5 and FIG. 6 the battery packs may also include a switch control that may engage or disengage a particular battery pack. For example, FIG. 5 depicts the use of a two-tier switch control system. The first tier may be represented with the use of DC disconnector switch 330-1 that connects/disconnects battery pack 320-1, the use of DC disconnector switch 330-2 that connects/disconnects battery pack 320-2, and the use of DC disconnector switch 330-3 that connects/disconnects battery pack 320-3. The same arrangement is illustrated with the use of DC disconnector switches 335 that connects/disconnects battery packs 325. Further, the second tier of switch control may be directed to the use of main DC box switch 340-1 that completely connects/disconnects battery pack 320-1, battery pack 320-2, and battery pack 320-3. And similarly, the second tier of switch control may be directed to the use of main DC box switch 340-2 that completely connects/disconnects battery pack 325-1, battery pack 325-2, and battery pack 325-3. The use of a first and second tier switch control may allow for a finer modularity of control for the matching of energy between DC block enclosures and power conversion modules as previously discussed.

At step 515 the method continues with a coupling of a plurality of serially coupled battery modules to form a second battery pack. As discussed in FIG. 5, a first battery pack may be considered as including battery pack 320-1, battery pack 320-2, and battery pack 320-3. In an analogous manner, a second battery pack may be considered as including battery pack 325-1, battery pack 325-2, and battery pack 325-3.

At step 520 the method may continue with a coupling of a second switch control to the second battery pack. As discussed in FIG. 5, a first switch control may be considered as including a first and second tier switch control. The first tier may utilize DC disconnector switch 330-1 that connects/disconnects battery pack 320-1, the use of DC disconnector switch 330-2 that connects/disconnects battery pack 320-2, and the use of DC disconnector switch 330-3 that connects/disconnects battery pack 320-3. The second-tier switch control for the first switch control may utilize DC box switch 340-1 that completely connects/disconnects battery pack 320-1, battery pack 320-2, and battery pack 320-3.

The same arrangement is illustrated with the coupling of a second switch control to the second battery pack with use of a first tier of switch control that utilizes DC disconnector switches 335 that connects/disconnects battery packs 325. And similarly, the second tier of switch control may be directed to the use of main DC box switch 340-2 that completely connects/disconnects battery pack 325-1, battery pack 325-2, and battery pack 325-3.

At step 525 the method may continue with a determining, based on an amount of energy mismatch between the second battery pack and the first or the second power conversion module, when to couple the second switch control to a first power conversion module or to a second power conversion module. As described in FIG. 6, the approach is to allow each DC bus or group of DC buses to connect with multiple inverter systems. For example, all of the output 415-1 and output 415-2 of DC block enclosure 410-1, output 415-3 and output 415-4 of DC block enclosure 410-2, and output 415-5 and output 415-6 of DC block enclosure 410-3 may be coupled to the inverter, power conversion module 420. However, as an example, if all of the output 415-7 and output 415-8 of DC block enclosure 410-4 were to be coupled to power conversion module 420 then such a set of connections may exceed the capacity of power conversion module 420. Thus, an enclosure or array controller may sense the imbalance or mismatch of energy and instead of connecting the output 415-8 of main DC box switch 340-2 of DC block enclosure 410-4 to power conversion module 420, that energy may be directed to another power conversion module, for example power conversion module 430.

The method may continue to step 530 with coupling the second switch control to a first power conversion module or to a second power conversion module based on the determining. As previously discussed, a control system controller or an array controller may determine how to best match and connect one or more DC block enclosures to one or more power conversion modules. A control system controller may be utilized within an enclosure to monitor and control how and when to connect a main DC box switch, or its equivalent, to a particular power conversion module. An array controller may be a system type controller used to monitor and control multiple DC block enclosures.

Method 500 may then end.

The description and abstract sections may set forth one or more embodiments of the present disclosure as contemplated by the inventor(s), and thus, are not intended to limit the present disclosure and the appended claims.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof may be appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by the above-described exemplary embodiments.

Exemplary embodiments of the present disclosure have been presented. The disclosure is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the disclosure.

What is claimed is:

1. An energy storage enclosure system for power distribution comprising:
a first battery pack comprising a plurality of serially coupled first battery modules;
a first switch control coupled to the first battery pack;
a second battery pack comprising a plurality of serially coupled second battery modules; and
a second switch control coupled to the second battery pack;
wherein the second switch control is configured to optionally couple to a first power conversion module or to a second power conversion module; and
wherein the option to couple to the first power conversion module or the second power conversion module is based on an amount of energy mismatch between the second battery pack and either the first power conversion module or the second power conversion module.

2. The energy storage enclosure system as recited in claim 1, wherein:
the first battery pack is electrically isolated from the second battery pack.

3. The energy storage enclosure system as recited in claim 1, wherein:
the first battery pack and the second battery pack comprise the same type and number of battery modules.

4. The energy storage enclosure system as recited in claim 1, further comprising:
a control system controller configured to determine when the second switch control is to be coupled to the first power conversion module or to the second power conversion module.

5. The energy storage enclosure system as recited in claim 1, further comprising:
a first energy storage enclosure coupled to the first power conversion module; and
a second energy storage enclosure coupled to the second power conversion module.

6. The energy storage enclosure system as recited in claim 5, further comprising:
an array controller configured to control:
the coupling of the second switch control of the first energy storage enclosure to the first power conversion module or the second power conversion module; and
the coupling of the second energy storage enclosure to the first power conversion module or the second power conversion module.

7. The energy storage enclosure system as recited in claim 5, wherein:
the first energy storage enclosure and the second energy storage enclosure are both fully populated with one or more battery packs.

8. The energy storage enclosure system as recited in claim 1, wherein:
at least one of the first power conversion module and the second power conversion module comprises an analog/digital inverter.

9. The energy storage enclosure system as recited in claim 1, wherein:
at least one of the first power conversion module and the second power conversion module is coupled to an external power source.

10. The energy storage enclosure system as recited in claim 1, wherein:
at least one of the first power conversion module and the second power conversion module is configured to convert alternating current power to direct current power and/or to convert direct power to alternative current power.

11. A method for single direct current block enclosure power distribution to multi-inverter systems comprising:
coupling, serially, a plurality of first battery modules to form a first battery pack;
coupling a first switch control to the first battery pack;
coupling, serially, a plurality of second battery modules to form a second battery pack;
coupling a second switch control to the second battery pack;
determining, based on an amount of energy mismatch between the second battery pack and either a first power conversion module or a second power conversion module, when to couple the second switch control to the first power conversion module or to the second power conversion module; and
coupling the second switch control to the first power conversion module or to the second power conversion module based on the determining.

12. The method as recited in claim 11, further comprising:
electrically isolating the first battery pack from the second battery pack.

13. The method as recited in claim 11, wherein:
the first battery pack and the second battery pack comprise the same type and number of battery modules.

14. The method as recited in claim 11, further comprising:
coupling a first energy storage enclosure to the first power conversion module; and
coupling a second energy storage enclosure to the second power conversion module.

15. The method as recited in claim 14, further comprising:
coupling an array controller configured to control:
the coupling of the second switch control of the first energy storage enclosure to the first power conversion module or the second power conversion module; and
the coupling of the second energy storage enclosure to the first power conversion module or the second power conversion module.

16. The method as recited in claim 14, wherein:
the first energy storage enclosure and the second energy storage enclosure are both fully populated with one or more battery packs.

17. The method as recited in claim 11, wherein:
at least one of the first power conversion module and the second power conversion module comprises an analog/digital inverter.

18. The method as recited in claim 11, wherein:
at least one of the first power conversion module and the second power conversion module is coupled to an external power source.

19. The method as recited in claim 11, further comprising:
converting, using at least one of the first power conversion module and the second power conversion module, alternating current power to direct current power and/or to convert direct power to alternative current power.

20. An energy storage enclosure system comprising:
a first battery pack comprising a plurality of serially coupled first battery modules;
a first switch control coupled to the first battery pack;
a second battery pack comprising a plurality of serially coupled second battery modules, wherein the first battery pack is electrically isolated from the second battery pack, and the first battery pack and the second battery pack comprise the same type and number of battery modules;
a second switch control coupled to the second battery pack;
a second energy storage enclosure coupled to a second power conversion module;
a control system controller configured to determine when the second switch control is to be coupled to a first power conversion module or to the second power conversion module;
an array controller configured to control:
the coupling of the second switch control of a first energy storage enclosure to the first power conversion module or the second power conversion module; and
the coupling of the second energy storage enclosure to the first power conversion module or the second power conversion module;
wherein the second switch control is configured to optionally couple to the first power conversion module or to the second power conversion module;
wherein the option to couple to the first power conversion module or the second power conversion module is based on an amount of energy mismatch between the second battery pack and either the first power conversion module or the second power conversion module;
wherein the first energy storage enclosure and the second energy storage enclosure are both fully populated with one or more battery packs;
wherein at least one of the first power conversion module and the second power conversion module comprises an analog/digital inverter;
wherein at least one of the first power conversion module and the second power conversion module is coupled to an external power source; and
wherein at least one of the first power conversion module and the second power conversion module is configured to convert alternating current power to direct current power and/or to convert direct power to alternative current power.
